(19) United States
(12) Patent Application Publication
(10) Pub. No.: US 2026/0036153 A1
(43) Pub. Date: Feb. 5, 2026

(54) Adjustable Furniture Leg Assembly

(71) Applicant: Yixiang Blow Molding Furniture Co., Ltd., Yuyao (CN)

(72) Inventors: Yixiang JIANG, Yuyao (CN); Shangxi JIANG, Yuyao (CN); Jinglei JIANG, Yuyao (CN)

(73) Assignee: Yixiang Blow Molding Furniture Co., Ltd., Yuyao (CN)

(21) Appl. No.: 19/054,939

(22) Filed: Feb. 17, 2025

(30) Foreign Application Priority Data
Aug. 2, 2024 (CN) 202422020374.1

(51) Int. Cl. F16B 7/14

(52) U.S. Cl. CPC F16B 7/1409

(57) ABSTRACT

The present invention discloses a telescopic tube assembly for furniture supports. The telescopic tube assembly comprises a first tube body and a second tube body that are nested together and can slide relative to each other. A steel ball is installed on the first tube body, and the wall of the first tube body has a mounting hole to accommodate the steel ball. The second tube body is sleeved over the first tube body, and the wall of the second tube body has a steel ball hole corresponding to the steel ball. The outer side of the second tube body is equipped with a pressing plate for pressing the steel ball inward, and the outer wall of the second tube body is fitted with a protective cover that encloses the end of the pressing plate.

### CROSS-REFERENCES TO RELATED APPLICATIONS

This application claims the priority of CN Patent Application No. CN202422020374.1, entitled “Adjustable Leg Assembly,” filed Aug. 2, 2024, which is incorporated herein by reference for all purposes.

### TECHNICAL FIELD

The present subject matter is in the field of furniture design and manufacture. More particularly, embodiments of the present subject matter relate to a furniture leg or support thar renders adjustable heights.

### BACKGROUND

A furniture's leg can adopt telescopic tube connections that can be adjusted to provide different height of the furniture. In existing telescopic tube connections with an upper and lower nested structure, a spring cap or ball protruding from the tube's locking hole is commonly used to secure the two sections in place. To adjust the tube's length, the user must press down directly on the spring cap with their finger, causing it to retract into the tube, allowing the upper tube section to slide downward and achieve the telescopic function.

Due to the gap between the spring cap and the tube's locking hole, users may easily pinch their fingers when pressing the spring cap, leading to injuries when the tube slides. Additionally, if there is a significant difference in diameter between the two tube sections, the tube edges can also cause pinching injuries during movement. Furthermore, if the spring cap is not very flexible, pressing it can be painful, resulting in a poor user experience.

Moreover, during the adjustment, it is common for the spring cap to fail to rebound and lock in place properly, causing unexpected sliding of the two tube sections, which may injure the user's fingers. In summary, there is a need for further improvements to the existing telescopic tube positioning mechanism for a furniture.

### SUMMARY OF THE SUBJECT MATTER

The technical problem to be solved by this present disclosure is to address the current technology by providing a telescopic tube positioning mechanism that is casy to operate, labor-saving, and prevents finger injuries during telescopic tube's length adjustments.

The technical solution adopted by this invention is to solve the above technical problem is: a telescopic tube positioning mechanism, where the telescopic tube comprises a first tube body and a second tube body that are nested and can slide relative to each other. A steel ball is installed on the first tube body, and correspondingly, the wall of the first tube body is provided with a mounting hole to accommodate the steel ball. The second tube body is sleeved over the first tube body, and the wall of the second tube body has a steel ball hole corresponding to the steel ball. The characteristic is that the outer side of the second tube body is equipped with a pressing plate used to press the steel ball inward, and a protective cover is installed on the outer wall of the second tube body, covering the end of the pressing plate.

To prevent the user from mistakenly flipping the pressing plate upward, the second tube body is positioned below the first tube body. The pressing plate has a pressing portion aligned with the steel ball, and the pressing portion extends downward into a handle. The protective cover is positioned below the steel ball hole and covers the handle externally.

To avoid shaking caused by excessive gaps between the first and second tube bodies, a nesting component is additionally installed between the first and second tube bodies. This nesting component is sleeved onto the first tube body and fixed to the second tube body, with the nesting component featuring an avoidance hole or avoidance slot to accommodate the steel ball.

The nesting component can be fixed to the second tube body in various ways. Preferably, the wall of the second tube body is provided with a positioning hole, while the nesting component has a protruding positioning block that is secured within the positioning holc.

Further preferably, the positioning hole and the steel ball hole are located on opposite sides of the second tube body.

As a preferred solution, the pressing plate and the nesting component are integrated into a single piece, with the pressing plate exposed on the outer side of the second tube body.

Further preferably, both the pressing plate and the nesting component are made of plastic.

As another preferred solution, the pressing plate and the second tube body are integrated into a single piece, with the pressing plate fixed on the outer wall of the second tube body.

Both the pressing plate and the second tube body can be made of metal or plastic, or another material.

Compared with the existing technology, this present invention has the following advantages: The telescopic tube positioning mechanism consists of a first tube body and a second tube body that are nested and can slide relative to each other. The first tube body is equipped with a steel ball, while the wall of the second tube body has a corresponding steel ball hole. Since the outer side of the second tube body is equipped with a pressing plate to press the steel ball inward and the outer wall of the second tube body has a protective cover at the end of the pressing plate, the user only needs to press the pressing plate to retract the steel ball inward during telescopic operation. Additionally, the large contact area between the fingers and the pressing plate prevents finger pain. Utilizing a lever arm makes pressing easier and more convenient. Furthermore, it prevents injuries caused by the tube moving up and down and pressing against the user's fingers, making it safer to use.

### DESCRIPTION OF DRAWINGS

The present subject matter is illustrated by way of example, and not by way of limitation, in the figures of the accompanying drawings and in which:

FIG. 1 is a schematic structural diagram of the telescopic tube positioning mechanism in one embodiment of the present disclosure;

FIG. 2 is an exploded schematic diagram of the telescopic tube positioning mechanism shown in FIG. 1;

FIG. 3 is an exploded schematic diagram of the telescopic tube positioning mechanism shown in FIG. 1 from another angle;

FIG. 4 is a sectional structural diagram of the telescopic tube positioning mechanism shown in FIG. 1;

FIG. 5 is a schematic structural diagram of the telescopic tube positioning mechanism in another embodiment of the present disclosure;

FIG. 6 is an exploded schematic diagram of the telescopic tube positioning mechanism shown in FIG. 5; and

FIG. 7 is a sectional structural diagram of the telescopic tube positioning mechanism shown in FIG. 5.

### DETAILED DESCRIPTION

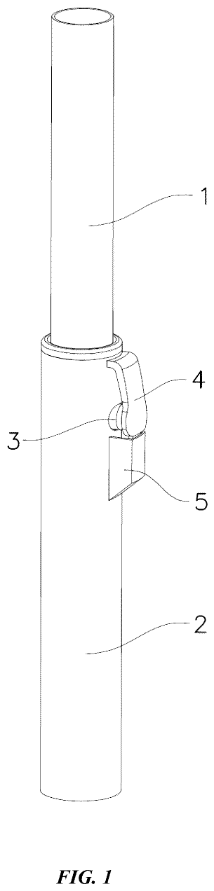

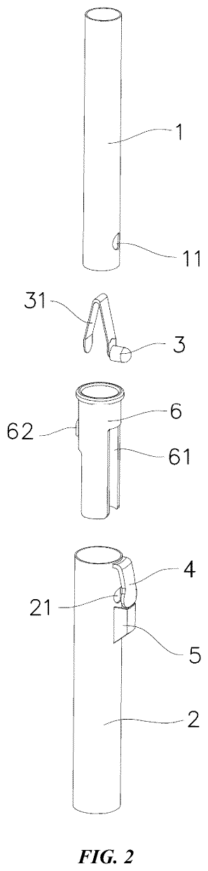

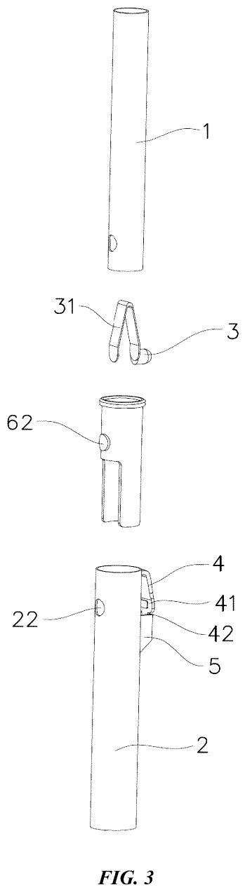

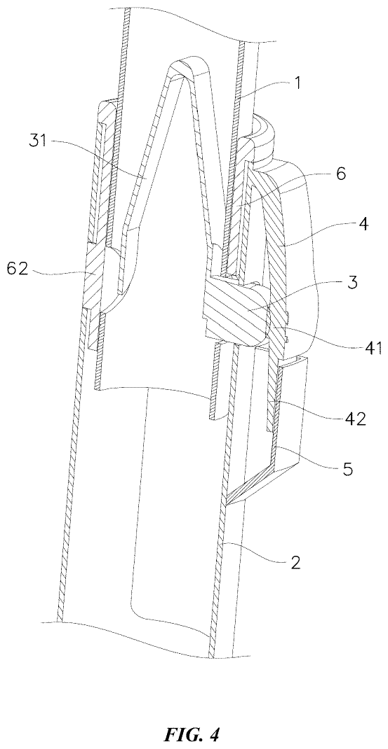

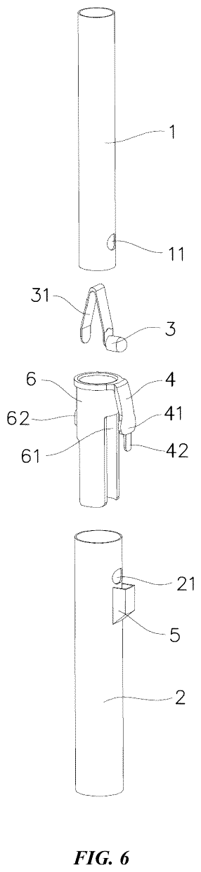

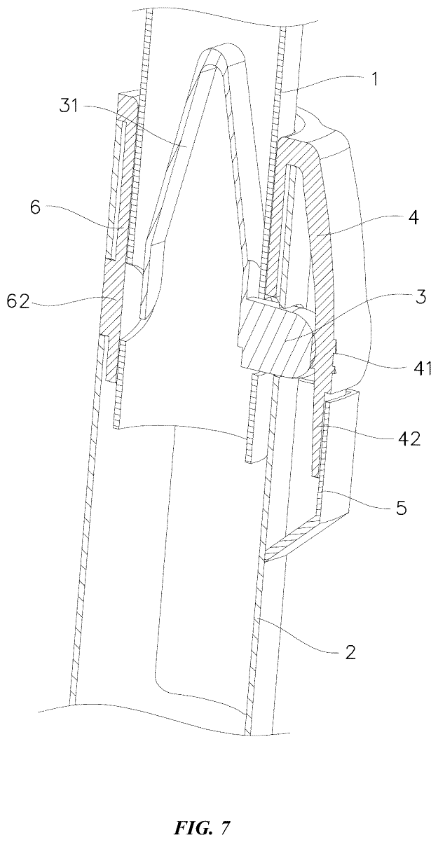

The present subject matter pertains to improved approaches for adjusting the height of a furniture leg or support. Embodiments of the present subject matter are discussed below with reference to FIGS. 1-7.

In the following description, for purposes of explanation, numerous specific details are set forth in order to provide a thorough understanding of the present subject matter. It will be apparent, however, to one skilled in the art that the present subject matter may be practiced without some of these specific details. In addition, the following description provides examples, and the accompanying drawings show various examples for the purposes of illustration. Moreover, these examples should not be construed in a limiting sense as they are merely intended to provide examples of embodiments of the subject matter rather than to provide an exhaustive list of all possible implementations. In other instances, well-known structures and devices are shown in block diagram form in order to avoid obscuring the details of the disclosed features of various described embodiments.

The present subject matter will be further described in detail below with reference to the embodiments of the accompanying drawings.

### Embodiment 1

As shown in FIGS. 1 to 4, the telescopic tube positioning mechanism in this embodiment comprises a first tube body (1) and a second tube body (2), which are nested together and can slide relative to each other. A steel ball (3) is installed on the first tube body (1). Correspondingly, the wall of the first tube body (1) has a mounting hole (11) to accommodate the steel ball (3). A spring plate (31) is installed inside the first tube body (1). When the steel ball (3) is pressed inward, the spring plate (31) compresses. Once the external force acting on the steel ball (3) disappears, the compressed spring plate (31) resets, causing the steel ball (3) to move forward and return to its original position under the elastic force of the spring plate (31).

The second tube body (2) is sleeved outside the first tube body (1) and positioned below it. The wall of the second tube body (2) has a steel ball hole (21) corresponding to the steel ball (3). When the first tube body (1) and the second tube body (2) are in a locked position, the steel ball (3) extends forward into the steel ball hole (21).

The outer side of the second tube body (2) is equipped with a pressing plate (4) for pressing the steel ball (3) inward. In this embodiment, the pressing plate (4) and the second tube body (2) are integrated as a single piece, both made of metal, with the pressing plate (4) welded to the outer wall of the second tube body (2). The pressing plate (4) has a pressing section (41) aligned with the steel ball (3), and the pressing section (41) extends downward into a handle (42). A protective cover (5) is installed on the outer wall of the second tube body (2), positioned below the steel ball hole (21), and covering the handle (42) externally. The function of the protective cover (5) is to prevent the user from mistakenly flipping the pressing plate (4) upward.

In this embodiment, a nesting component (6) is also installed between the first tube body (1) and the second tube body (2). The nesting component (6) is sleeved onto the first tube body (1), mainly to prevent shaking caused by excessive gaps between the first tube body (1) and the second tube body (2). The wall of the second tube body (2) has a positioning hole (22), which is located on the opposite side of the steel ball hole (21). The nesting component (6) has a protruding positioning block (62), which is secured within the positioning hole (22), thereby enabling the first tube body (1) and the second tube body (2) to be fixed together. Additionally, to accommodate the steel ball (3), the nesting component (6) has an avoidance hole, avoidance slot (61), or avoidance notch.

When the first tube body (1) and the second tube body (2) are locked together, the steel ball (3) extends forward into the steel ball hole (21). To enable telescopic movement, the user first presses the pressing plate (4), causing the steel ball (3) to move inward. Then, by pulling the first tube body (1) upward with force, the steel ball (3) disengages from the second tube body (2) and the nesting component (6), allowing the first tube body (1) to move upward relative to the second tube body (2). To lock the mechanism again, the user releases the pressing plate (4) and inserts the first tube body (1) downward. When the steel ball (3) reaches the position corresponding to the steel ball hole (21), the steel ball (3) pops forward under the action of the spring plate (31), passing through the steel ball hole (21), thereby locking the first tube body (1) and the second tube body (2) together.

### Embodiment 2

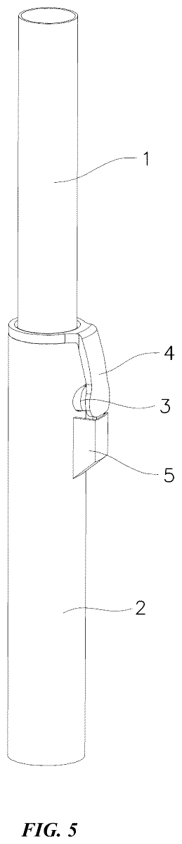

As shown in FIGS. 5 to 7, in this embodiment, the pressing plate (4) and the nesting component (6) are integrated as a single piece, both made of plastic. The pressing plate (4) is exposed on the outer wall of the second tube body (2), serving the same function of pressing the steel ball (3). The remaining structure and working principle of this embodiment are the same as in Embodiment 1 and will not be further described here.

Having disclosed exemplary embodiments and the best mode, modifications and variations may be made to the disclosed embodiments while remaining within the scope of the embodiments of the subject matter as defined by the following claims.

What is claimed is:

1. A telescopic tube assembly, wherein the telescopic tube assembly comprises a first tube body (1) and a second tube body (2) that are nested together and can slide relative to each other, wherein a steel ball (3) is installed on the first tube body (1), and correspondingly, the wall of the first tube body (1) has a mounting hole (11) to accommodate the steel ball (3), wherein the second tube body (2) is sleeved over the first tube body (1), and the wall of the second tube body (2) has a steel ball hole (21) corresponding to the steel ball (3), wherein a distinguishing feature is that the outer side of the second tube body (2) is provided with a pressing plate (4) for pressing the steel ball (3) inward, and the outer wall of the second tube body (2) is fitted with a protective cover (5) that encloses the end of the pressing plate (4).

2. The telescopic tube assembly of claim 1, characterized in that the second tube body (2) is positioned below the first tube body (1), wherein the pressing plate (4) has a pressing section (41) aligned with the steel ball (3), and the pressing section (41) extends downward into a handle (42), wherein the protective cover (5) is positioned below the steel ball hole (21) and encloses the handle (42) externally.

3. The telescopic tube assembly of claim 1, wherein a nesting component (6) is further installed between the first tube body (1) and the second tube body (2), wherein the nesting component (6) is sleeved onto the first tube body (1) and fixed to the second tube body (2), with the nesting component (6) having an avoidance hole or avoidance slot (61) to accommodate the steel ball (3).

4. The telescopic tube assembly of claim 3, wherein the wall of the second tube body (2) has a positioning hole (22), while the nesting component (6) has a protruding positioning block (62), which is secured within the positioning hole (22).

5. The telescopic tube assembly of claim 4, wherein the positioning hole (22) and the steel ball hole (21) are located on opposite sides of the second tube body (2).

6. The telescopic tube assembly of claim 1, wherein the pressing plate (4) and the nesting component (6) are integrated into a single piece, with the pressing plate (4) exposed on the outer side of the second tube body (2).

7. The telescopic tube assembly of claim 6, wherein both the pressing plate (4) and the nesting component (6) are made of plastic.

8. The telescopic tube assembly of claim 5, wherein the pressing plate (4) and the second tube body (2) are integrated into a single piece, with the pressing plate (4) fixed on the outer wall of the second tube body (2).

9. The telescopic tube assembly of claim 8, wherein both the pressing plate (4) and the second tube body (2) are made of metal.
